(19) United States
(12) Patent Application Publication
(10) Pub. No.: US 2026/0222236 A1
(43) Pub. Date: Jul. 30, 2026

(54) PRESENTER FOCUS MODE FOR SHARING CONTENT IN ONLINE MEETINGS

(71) Applicant: Microsoft Technology Licensing, LLC, Redmond, WA (US)

(72) Inventors: Defne KUDELA, Prague (CZ); Nakul MADAAN, Munich (DE); Mihai Alexandru MEDINTU, Prague (CZ); Mario NOVOSELEC, Prague (CZ)

(73) Assignee: Microsoft Technology Licensing, LLC, Redmond, WA (US)

(21) Appl. No.: 19/041,104

(22) Filed: Jan. 30, 2025

(51) Int. Cl. H04L 12/18; G06F 40/20

(52) U.S. Cl. CPC H04L 12/1813; G06F 40/20

(57) ABSTRACT

A data processing system implements receiving user selection information, from a first client device of a first user, indicating a plurality of user selections of content from multiple locations of one or more files; analyzing the user selection information to extract data and formatting information associated with each selection of the plurality of user selections; formatting the data extracted into data structures representing the data and formatting information; receiving a content sharing command from the first client device to share content with one or more second client devices participating in an online meeting via an online meeting platform; and in response to receiving the content sharing command: generating a graphical representation of the plurality of user selections based on the data structures; and providing the graphical representation to the first client device and one or more second client devices participating in the online meeting via the online meeting platform.

### BACKGROUND

Online meeting platforms enable users to conduct video conferences and collaborate with other users. Screen sharing enables users to share the contents of documents on the screen of their devices with other users in the meeting. These documents are often developed collaboratively and may include comments, changes, and revisions that can clutter the screen and distract the meeting participants from the main content. Furthermore, a user may wish to share content from multiple documents, but current online meeting platforms only permit the user to share content from a single document at a time and switch between documents. Alternatively, the user may share their entire desktop. However, this approach requires the user to switch among multiple documents and/or application windows which can interrupt the meeting workflow. Furthermore, the user may inadvertently share sensitive content on their screen using this approach. Hence, there is a need for improved systems and methods for sharing content during online meetings.

### SUMMARY

An example data processing system according to the disclosure includes a processor and a memory storing executable instructions. The instructions when executed cause the processor alone or in combination with other processors to perform operations including receiving user selection information, from a first client device of a first user, indicating a plurality of user selections of content from multiple locations of one or more files; analyzing the user selection information to extract data and formatting information associated with each selection of the plurality of user selections; formatting the data extracted into data structures representing the data and formatting information; receiving a content sharing command from the first client device of the first user to share content with one or more second client devices participating in an online meeting via an online meeting platform; and in response to receiving the content sharing command: generating a graphical representation of the plurality of user selections based on the data structures representing the data and formatting information; and providing the graphical representation to the first client device and one or more second client devices participating in the online meeting via the online meeting platform.

An example method implemented in a data processing system includes receiving user selection information, from a first client device of a first user, indicating a plurality of user selections of content from multiple locations of one or more files; analyzing the user selection information to extract data and formatting information associated with each selection of the plurality of user selections; formatting the data extracted into data structures representing the data and formatting information; receiving a content sharing command from the first client device of the first user to share content with one or more second client devices participating in an online meeting via an online meeting platform; and in response to receiving the content sharing command: generating a graphical representation of the plurality of user selections based on the data structures representing the data and formatting information; and providing the graphical representation to the first client device and one or more second client devices participating in the online meeting via the online meeting platform.

An example machine-readable medium on which are stored instructions that, when executed, cause a processor of alone or in combination with other processors to perform operations of receiving user selection information, from a first client device of a first user, indicating a plurality of user selections of content from multiple locations of one or more files; analyzing the user selection information to extract data and formatting information associated with each selection of the plurality of user selections; formatting the data extracted into data structures representing the data and formatting information; receiving a content sharing command from the first client device of the first user to share content with one or more second client devices participating in an online meeting via an online meeting platform; and in response to receiving the content sharing command: generating a graphical representation of the plurality of user selections based on the data structures representing the data and formatting information; and providing the graphical representation to the first client device and one or more second client devices participating in the online meeting via the online meeting platform.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a diagram of an example computing environment in which the techniques for sharing content during an online meeting described herein are implemented.

FIG. 2 is a diagram showing an example implementation of the content sharing unit implemented on the client device shown in FIG. 1.

FIG. 3 is a diagram showing an example implementation of the content sharing unit implemented on the application services platform shown in FIG. 1.

FIG. 4A-4J are diagrams showing an example of the content sharing techniques provided herein being utilized in applications.

FIG. 5 is a diagram showing an example of the data structures that can be generated by the data extraction unit of the content sharing unit.

FIG. 6 is a flow chart of an example process for sharing content in an online meeting according to the techniques disclosed herein.

FIG. 7 is a block diagram showing an example software architecture, various portions of which may be used in conjunction with various hardware architectures herein described, which may implement any of the described features.

FIG. 8 is a block diagram showing components of an example machine configured to read instructions from a machine-readable medium and perform any of the features described herein.

### DETAILED DESCRIPTION

Systems and methods for sharing content during an online meeting are provided that provide a technical solution to the technical problems associated with current approaches to sharing content on current online meeting platforms. These techniques provide a focus mode for sharing content in which a user can select content from one or more locations of one or more files to be shared with participants of an online meeting and a shareable graphical representation is generated from the selected content. The graphical representation of the user selections provides a clean and uncluttered view of the selected content for presentation to the participants of the online meeting. The content sharing unit utilizes a language model trained to generate a layout of the selected content in the graphical representation in some implementations. In other implementations, the content sharing unit utilizes templates selected from among a plurality of templates for generating the layout of the graphical representation of the user selections. The templates can be selected based on the number of selections to be included in the generated file and/or the types of content to be included in the file. A technical benefit of these techniques is that the user can select content from one or more locations in a file and/or from one or more files and the system automatically generates a single graphical representation that includes the shared content in a coherent in streamlined layout that is conducive to sharing in an online meeting. This approach can significantly improve the workflow of online meetings by enabling users to focus on important details of the shared content without being distracted by comments, markups, and portions of the content that are irrelevant to the online meeting. Consequently, this approach can reduce the computing resources utilized by the online meeting platform by making online meetings more efficient and eliminating meeting time that would otherwise be expended on explaining more complicated and unfocused shared content. These and other technical benefits of the techniques disclosed herein will be evident from the discussion of the example implementations that follow.

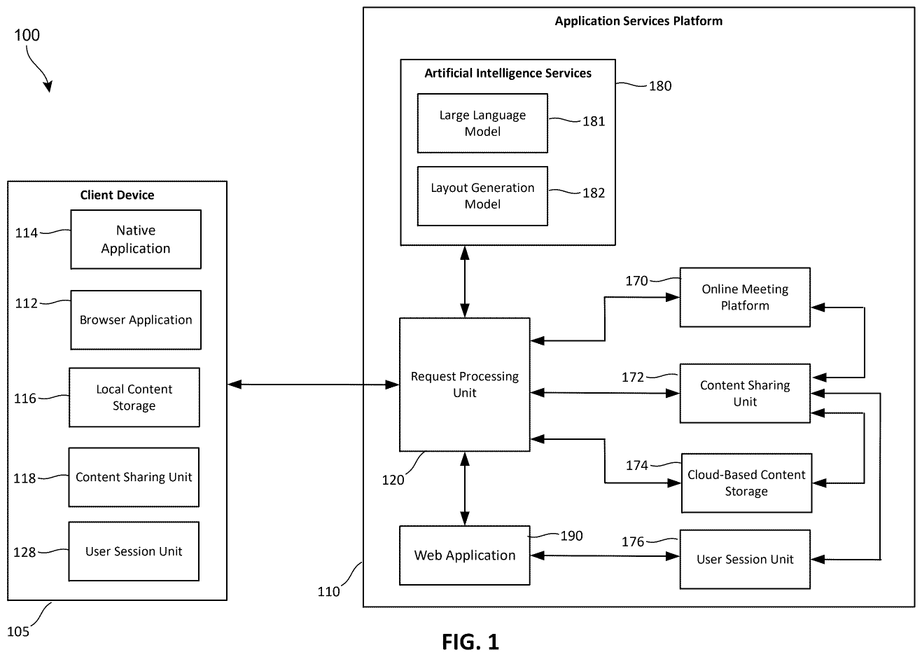

FIG. 1 is a diagram of an example computing environment 100 in which the techniques for sharing content is an online meeting described herein are implemented. The example computing environment 100 includes a client device 105 and an application services platform 110. The application services platform 110 provides one or more cloud-based applications and/or provides services to support one or more web-enabled native applications on the client device 105. These applications may include but are not limited to design applications, word processing applications, spreadsheet applications, slide applications, communications platforms, visualization tools, and/or collaboration tools for collaboratively creating visual representations of information, and other applications for consuming and/or creating electronic content. The client device 105 and the application services platform 110 communicate with each other over a network (not shown). The network may be a combination of one or more public and/or private networks and may be implemented at least in part by the Internet. While the example shown in FIG. 1 includes a single client device, the application services platform 110 is capable of supporting multiple client devices simultaneously accessing the services provided by the application services platform 110.

The request processing unit 120 receives requests from an application implemented by the native application 114 of the client device 105 and/or the web application 190 of the application services platform 110. The web application 190 can be accessed using the browser application 112 While the implementation shown in FIG. 1 includes a single native application and web application, other implementation may include multiple native applications implemented on the client device 105 and/or multiple web applications implemented on the application services platform 110. A user may utilize a combination of native applications and/or web applications in some implementations. The request processing unit 120 coordinates requests provides requests received from native application 114 and/or web application 190 to the appropriate components of the application services platform 110 for processing.

The online meeting platform 170 implements functionality for conducting online meetings. The online meeting platform 170 can provide additional functionality such as but not limited chat and/or messaging functionality, collaboration functionality, file storage functionality, and/or other such features that enable users to communicate with and/or collaborate with other users. The online meeting platform 170 provides functionality that enables a meeting participant to share content with other meeting participants during an online meeting. The shared content can include content selected from one or more files on the client device 105 and/or stored in the local content storage 116 of the client device and/or the cloud-based content storage 174 of the application services platform 110. The local content storage 116 is a persistent memory of the client device 105 in which the various data, such as but not limited to files, user selection information, and/or data structures comprising data extracted from the user selection information, can be stored and accessed by components of the client device 105. The cloud-based content storage 174 is a persistent memory of the application services platform 110 in which the various data, such as but not limited to files, user selection information, and/or data structures comprising data extracted from the user selection information, can be stored and accessed by components of the application services platform 110. The shared content can be from a file selected by a participant of a meeting via a user interface provided by the online meeting platform 170 or can be obtained from the content sharing unit 172 as indicated in the examples which follow. The shared content is streamed to the client devices of the participants of the online communication session, such as the client device 105.

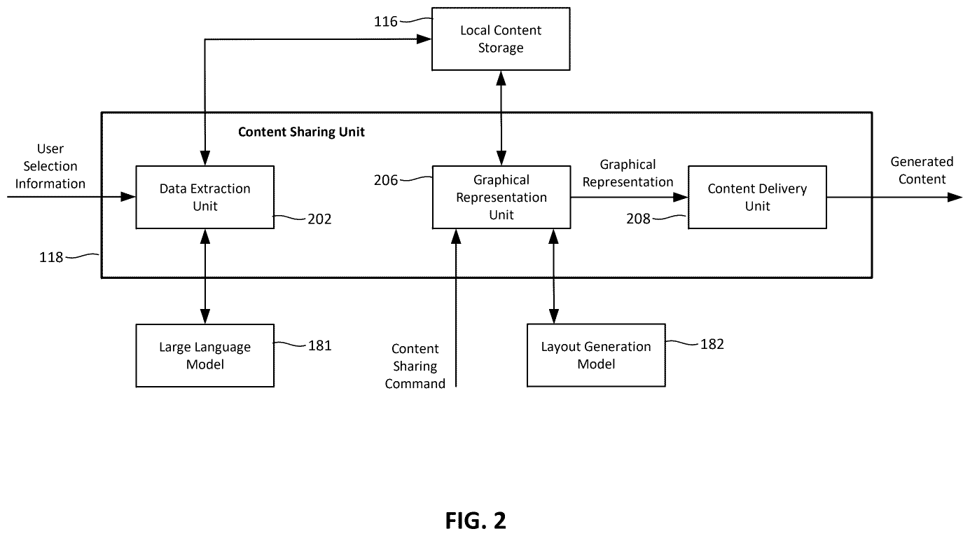

The content sharing unit 172 implements the content sharing techniques herein for sharing content selected from one or more locations of one or more files with participants of an online meeting. The files may be associated with different applications. For instance, in a non-limiting example, a participant selects one or more portions of a textual document in a word processing application and one/or more portions of a spreadsheet in a spreadsheet application to be shared with the participants of the online meeting. The content sharing unit 172 receives an indication which content was selected by the user in the textual document and the spreadsheet, analyzes the user selections to extract data and formatting information associated with each selection of the plurality of user selections, and formatting the data extracted into data structures representing the data and formatting information. The user selections can include various types of user selections, such as but not limited to a free-form selection, a rectangular selection of content, and/or a click indicating the selection of a particular object. The content sharing unit 172 receives a content sharing command from the client device 105 of the user that selected the content. The content sharing command indicates that the user has completed the selection of content to be shared, and that the user selections should be shared with the client devices of the participants of the online meeting. The content sharing unit 172 generates a graphical representation of the user selections and provides the graphical representation to the client devise of the participants of the online meeting. Additional details of the content sharing unit 172 are shown in FIG. 2.

The user session unit 176 is an optional component that is included in some implementations. The user session unit 176 implements a user session in the memory of the application services platform 110. The user session is initiated when the user makes a user selection of content to be shared during an online meeting. The user session includes a timer that counts from a most recent user selection that is received by the content sharing unit 172. The data extraction unit 302 of the content sharing unit 172 provides an indication to the user session unit 176 that one or more user selections have been received. The time resets each time that another user selection is received. The user session unit 176 determines that the timer has elapsed and generates a content sharing command that is provided to the content sharing unit 172 to cause the content sharing unit 172 to analyze the user selections and generate the graphical representation of the user selections. In some implementations, the content sharing unit 172 will prompt the user to confirm that no further user selections are to be provided for the user session, and the graphical representation can be generated. The user can respond to the prompt indicating that the user is still selecting additional content to share, and the content sharing unit 172 sends an indication to the user session unit 176 to reset the timer.

The artificial intelligence (AI) services 180 provide various machine learning models that analyze and/or generate content. The AI services 180 include a large language model 181 and a layout generation model 182. Some instances of the AI services 180 include other types of AI models, which may include but are not limited to models configured to generate textual content, image content, video content, and/or other types of content in response to a natural language prompt.

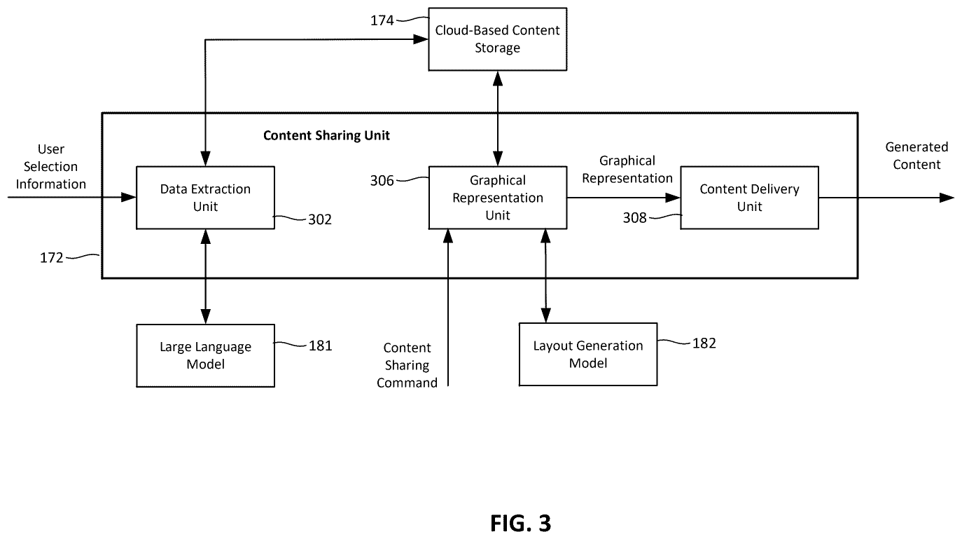

The large language model 181 is an artificial intelligence model that is trained to receive a textual prompt and to generate a textual output based on the textual input. The large language model 181 can be implemented using language models having various model architectures. Some implementations utilize a Generative Pre-Trained Transformer (GPT) language model to implement the large language model 181. The large language model 181 can be implemented by a multimodal model in some implementations that is capable of receiving multiple types of inputs and generating a textual output based on these inputs. In such multimodal implementations, the large language model 181 can receive a textual prompt that instructs the large language model 181 to generate specific content and to utilize the other inputs to provide context for the textual content to be generated by the model. For instance, in a non-limited example, the textual prompt can include instructions for analyzing content selected by a user to be shared with participants of an online meeting to extract data from the selected content, to determine layout information for the selected content, and/or perform other such actions on the selected content that can be utilized by the content sharing unit 118 of the client device 105 and/or the content sharing unit 172 of the application services platform 110 to extract information from the user selections that can be used to generate a representation of the user selections that can be shared with the participants of the online meeting. Additional details of how the content sharing unit 118 and/or the content sharing unit 172 can utilize the large language model 181 are shown in FIGS. 2 and 3.

The layout generation model 182 is a model that is a multimodal model that receives a textual prompt instructing the model to generate a layout for the content associated with multiple user selections. The layout generation model 182 can be implemented using language models having various model architectures. Some implementations utilize a Generative Pre-Trained Transformer (GPT) language model to implement the layout generation model 182. In some implementations, the layout generation model 182 is implemented by the same model as the large language model 181, and the output of the model is controlled by constructing a prompt that instructs the model to generate the layout of the selected content to be shared with the participants of the online meeting. The content sharing unit 118 of the client device 105 and/or the content sharing unit 172 of the application services platform 110 use the layout generation model 182 to generate a layout of the graphical representation of the selected content in some implementations. Additional details of how the content sharing unit 118 and/or the content sharing unit 172 can utilize the layout generation model 182 are shown in FIGS. 2 and 3.

The client device 105 is a computing device that may be implemented as a portable electronic device, such as a mobile phone, a tablet computer, a laptop computer, a portable digital assistant device, a portable game console, and/or other such devices in some implementations. The client device 105 may also be implemented in computing devices having other form factors, such as a desktop computer, vehicle onboard computing system, a kiosk, a point-of-sale system, a video game console, and/or other types of computing devices in other implementations. While the example implementation illustrated in FIG. 1 includes a single client device, other implementations may include a different number of client devices that utilize services provided by the application services platform 110.

The client device 105 includes a native application 114 and a browser application 112. The native application 114 that enables users to view, create, and/or modify electronic content. The native application 114 utilizes services provided by the application services platform 110 including but not limited to creating, viewing, and/or modifying various types of electronic content. Some implementations of the native application 114 are a web-enabled application that obtains at least a portion of the content and/or functionality of the application from the application services platform 110. The native application 114 can utilize the application services platform 110 to generate image contents in response to user prompts. In other implementations, the browser application 112 is used for accessing and viewing web-based content provided by the application services platform 110. In such implementations, the application services platform 110 implements one or more web applications, such as the web application 190, that enables users to view, create, and/or modify electronic content. The application services platform 110 supports both web-enabled native applications and a web application in some implementations, and the users may choose which approach best suits their needs.

The content sharing unit 118 implements the content sharing techniques shown herein. The content sharing unit 118 is implemented on the client device 105 and implements content sharing for content from one or more files stored in the local content storage 116 of the client device 105. The content sharing unit 118 operates similarly to the content sharing unit 172. The files stored in the local content storage 116 may be associated with different applications. The content sharing unit 118 receives an indication which content was selected by the user in the textual document and the spreadsheet, analyzes the user selections to extract data and formatting information associated with each selection of the plurality of user selections, and formatting the data extracted into data structures representing the data and formatting information. The content sharing unit 118 receives a content sharing command from the client device 105 of the user that selected the content. The content sharing command indicates that the user selections should be shared with the client devices of the participants of the online meeting. The content sharing unit 118 generates a graphical representation of the user selections and provides the graphical representation to the client devise of the participants of the online meeting. Additional details of the content sharing unit 172 are shown in FIG. 3.

The user session unit 128 is an optional component that is included in some implementations. The user session unit 128 implements a user session in the memory of the client device 105. The user session is initiated when the user makes a user selection of content to be shared during an online meeting. The user session includes a timer that counts from a most recent user selection that is received by the content sharing unit 118. The data extraction unit 202 of the content sharing unit 118 provides an indication to the user session unit 128 that one or more user selections have been received. The time resets each time that another user selection is received. The user session unit 128 determines that the timer has elapsed and generates a content sharing command that is provided to the content sharing unit 118 to cause the content sharing unit 118 to analyze the user selections and generate the graphical representation of the user selections. In some implementations, the content sharing unit 118 will prompt the user to confirm that no further user selections are to be provided for the user session, and the graphical representation can be generated. The user can respond to the prompt indicating that the user is still selecting additional content to share, and the content sharing unit 118 sends an indication to the user session unit 128 to reset the timer.

FIG. 2 is a diagram showing an example implementation of the content sharing unit 118 implemented on the client device 105 shown in FIG. 1. In some implementations, the functionality of the content sharing unit 118 may be implemented by one or more native applications, such as the native application 114, and/or the browser application 112 of the client device 105. The content sharing unit 118 receives user selection information which identifies content that has been selected from one or more locations of one or more files. The content sharing unit 118 can receive this information from a native application, such as the native application 114, and/or the browser application 112. Furthermore, the user selections may be received from more than one application. The user selections can also be received sequentially as a series of user selection information as the user selections are completed by the user. The content sharing unit 118 can receive a content sharing command from the native application 114 or the browser application 112 indicating that the content selection process has been completed. The native application 114 and/or the browser application 112 can include a button or other control that is actuated by the user to indicate that the content selection process is complete. In some implementations, the content sharing command is automatically generated by the native application 114, the browser application 112, and/or by user session unit 128 associated with the user making the selections. Example of a user interface of the native application 114 and/or the browser application 112 are shown in the examples which follow.

The data extraction unit 202 receives the user selection information and extracts the data and formatting information from the files associated with the selected content. The files may be stored in the local content storage 116. The user selection information can include various types of information identifying the selected content that can be used by the data extraction unit 202. The specific type of information included in the user selection information may depend, at least in part, on the type of content that is being selected. For instance, a user selection of content from a spreadsheet may include identifiers for the selected cells of the spreadsheet and/or identifiers of a selected chart, graph, histogram, or other content generated from the data in the spreadsheet. In another non-limiting example, the user selection information associated with a word processing file may include a paragraph indicator, a range of selected characters of text, or an indication of a chart, image, or other content element included in the word processing document. The data extraction unit 202 can access the file in the local content storage 116 and extract the data and formatting information associated with the user selection from the file. The data extraction unit 202 filters out annotations, markups, and/or comments associated with the user selections so that the graphical representation generated from the user selections is free from such potentially distracting elements.

In some implementations, the user selection information includes an image or screen shot representing the contents of the user interface of the native application 114 and/or the browser application 112 and an indication of a file in the local content storage 116 associated with the user selection. The image includes an indication of one or more portions of the user interface that have been selected by the user. These selections are highlighted or otherwise associated with an indication that the user has selected a portion of the content shown in the user interface of the native application 114 or the browser application 112. In such implementations, the data extraction unit 202 constructs a prompt to the large language model 181 instructing the model to analyze the image and the file associated with the image to determine which portion or portions of the content of the file were selected by the user. The format of the output by the large language model 181 depends on the type of file being analyzed. For instance, in a non-limiting example, the output by the large language model 181 may identify a set of set of cells from a spreadsheet or a paragraph of a document that was selected. The data extraction unit 202 can access the file in the local content storage 116 and extract the data and formatting information associated with the user selection from the file.

The data extraction unit 202 formats the data extracted from the user selection information into data structure representing the data and formatting information indicating how the data is formatted. The formatting information can include, but is not limited, to a font utilized to represent the data, a font size, and font color associated with textual content. The formatting information can also include positional information indicating the position of the various elements of the content selected by the user. The data extraction unit 202 can store the data in various types of data structures. In some implementations, the data extraction unit 202 generates JavaScript Notation Objects (JSON) representing each of the selected portions of the content. The JSON object may include data extracted from a file stored in the local content storage 116 and/or provide references to the portions of the document that were included in a user selection so that the user selections can be combined into a single graphical representation by the content sharing unit 118. In other implementations, the data extraction unit 202 stores the user selection data in a lightweight database. In some implementations, the user information can include pointers to the portions of the files selected by the user, and these pointers are used by the content sharing unit 118 to access the selected content and generate the graphical representation of the user selections. A technical benefit of this approach is that such lightweight databases require minimal configuration and utilize only a small amount of computing resources. Therefore, the lightweight database does not require a significant amount of computing resources on the client device 105.

The content sharing unit 118 can receive a content sharing command from the native application 114, the browser application 112, and/or the user session unit 128. The content sharing command indicates that the user has completed the selection of content to be shared, and that the user selections should be shared with the client devices of the participants of the online meeting. The graphical representation unit 206 of the content sharing unit 118 receives the content sharing command and accesses the user selection information associated with the user selections from the local content storage 116 and generates a graphical representation of the user selections based on the data structures representing the data and formatting information. In some implementations, the graphical representation unit 206 relies on the layout generation model 182 to generate a layout for the graphical representation when the user has made multiple user selections of content to be shared. The graphical representation unit 206 constructs a prompt instructing the layout generation model 182 to generate a layout for the user selections and provides the user selection information for each of the user selections to the layout generation model 182 as inputs to the layout generation model 182. The layout generation model 182 then outputs a graphical representation of the user selections. The graphical representation can be an image or an electronic document that is capable of being shared with the participants of an online meeting.

In other implementations, the graphical representation unit 206 of the content sharing unit 118 utilizes templates selected from among a plurality of templates for generating the layout of the graphical representation of the user selections. The templates can be selected based on the number of selections to be included in the generated graphical representation and/or the types of content to be included in the graphical representation. A technical benefit of these techniques, whether using the layout generation model or templates, is that the user can select content from one or more locations in a file and/or from one or more files and the system automatically generates a single graphical representation that includes the shared content in a coherent in streamlined layout that is conducive to sharing in an online meeting.

The content delivery unit 208 provides the graphical representation to the first client device and one or more second client devices participating in the online meeting via the online meeting platform. In some implementations, the content delivery unit 208 provides the graphical representation to the online meeting platform 170 on the application services platform 110 to provide to the second client devices of other users participating in the online meeting. The online meeting platform 170 can then send the graphical representation to the respective client devices of the other participants of the online meeting platform 170, and the graphical representation can be presented on a user interface of an application presenting the online meeting on the respective client devices of the other participants. The content sharing unit 118 can also provide the graphical representation to the application on the client device 105 that the user sharing content is using to participate in the online meeting. The online meeting platform 170 can integrate the graphical representation into a data stream being sent to the client devices of the participants of the online meeting in some implementations. In other implementations, the online meeting platform 170 provides an application programming interface (API) that is available to the content sharing unit 118 that enables the content sharing unit 118 to send the graphical representation to the client devices of the participants of the online meeting and/or insert the graphical representation into a stream sent to the client devices of the participants of the online meeting.

A technical benefit of the approach shown in FIG. 2 is that the user can select content from one or more locations in a file and/or from one or more files and the system automatically generates a single graphical representation that includes the shared content in a coherent in streamlined layout that is conducive to sharing in an online meeting. This approach can significantly improve the workflow of online meetings by enabling users to focus on important details of the shared content without being distracted by comments, markups, and portions of the content that are irrelevant to the online meeting. Consequently, this approach can reduce the computing resources utilized by the online meeting platform by making online meetings more efficient and eliminating meeting time that would otherwise be expended on explaining more complicated and unfocused shared content.

FIG. 3 is a diagram showing an example implementation of the content sharing unit 172 implemented on the application services platform 110 shown in FIG. 1. The data extraction unit 302 operates similarly to the data extraction unit 202 of the content sharing unit 118. The data extraction unit 302 receives user selection information from one or more web applications, such as the web application 190 of the application services platform 110. Users can access these web applications via the browser application 112 on the client device 105. The data extraction unit 302 stores data in the cloud-based content storage 174 on the application services platform 110.

The graphical representation unit 306 operates similarly to the graphical representation unit 206 of the content sharing unit 118. The graphical representation unit 306 receives a content sharing command from the one or more web applications and generates a graphical representation of the user selections received by the content sharing unit 172. Once the graphical representation has been created by the graphical representation unit 306, the content delivery unit 308 provides the graphical representation to the client devices of the participants of the online meeting in a similar manner as the content delivery unit 208 of the content sharing unit 118.

A technical benefit of the approach shown in FIG. 3 is that the user can select content from one or more locations in a file and/or from one or more files and the system automatically generates a single graphical representation that includes the shared content in a coherent in streamlined layout that is conducive to sharing in an online meeting. This approach can significantly improve the workflow of online meetings by enabling users to focus on important details of the shared content without being distracted by comments, markups, and portions of the content that are irrelevant to the online meeting. Consequently, this approach can reduce the computing resources utilized by the online meeting platform by making online meetings more efficient and eliminating meeting time that would otherwise be expended on explaining more complicated and unfocused shared content.

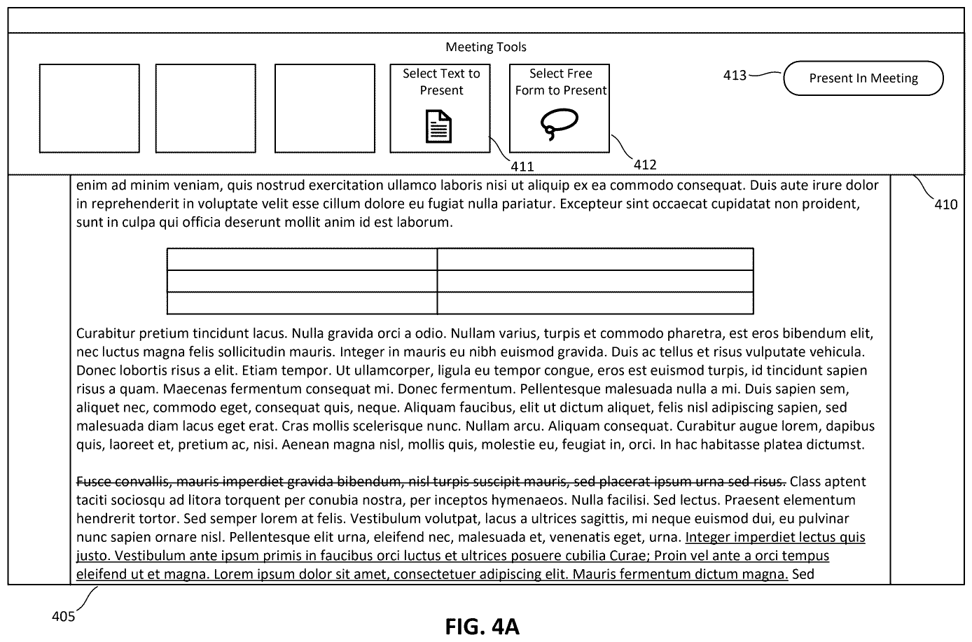

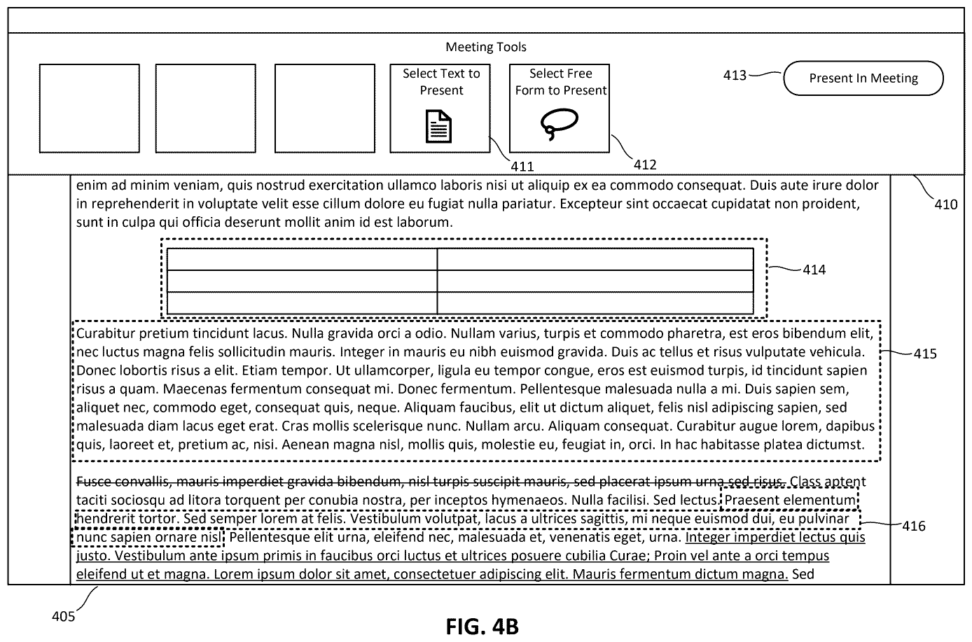

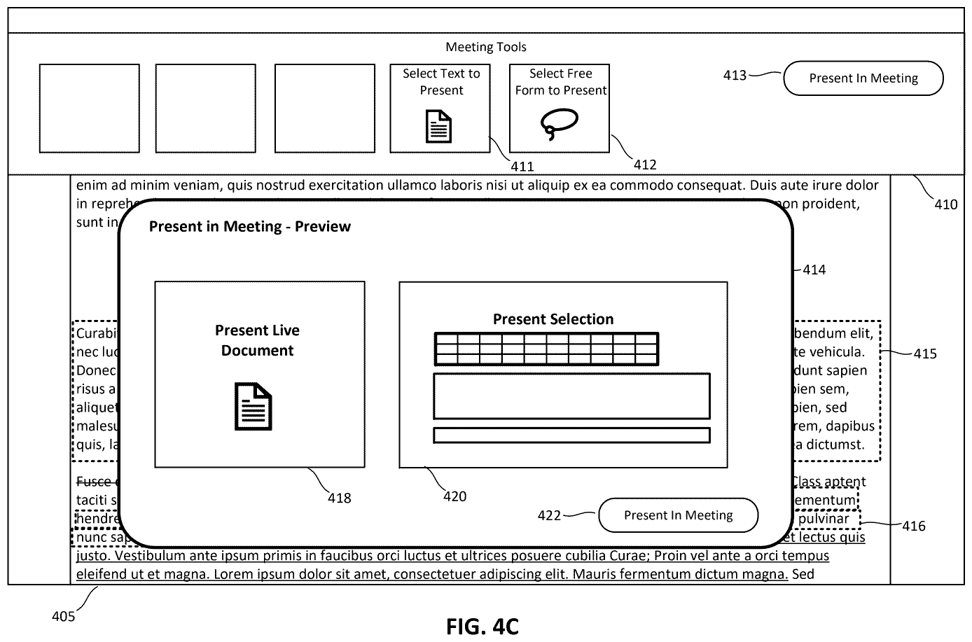

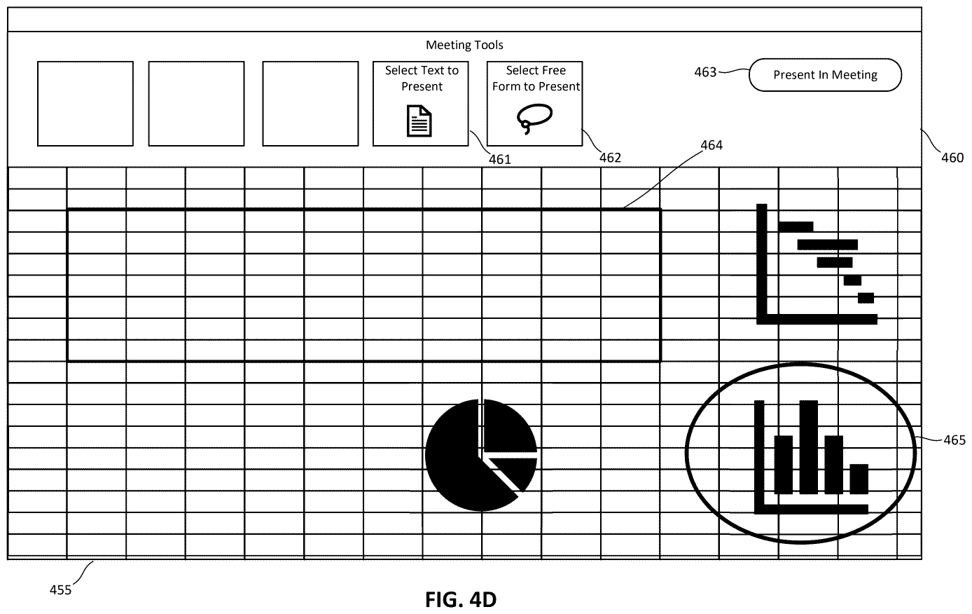

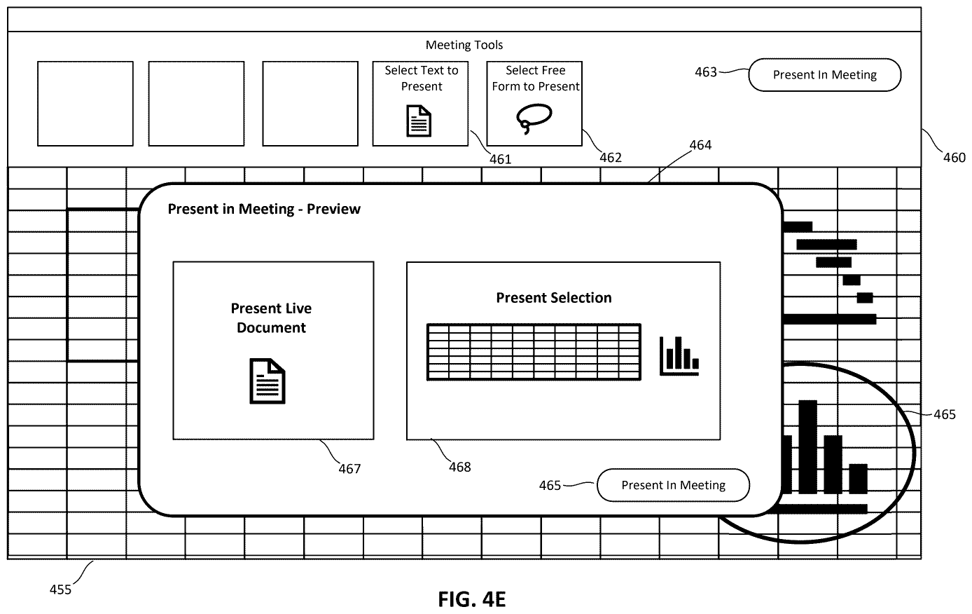

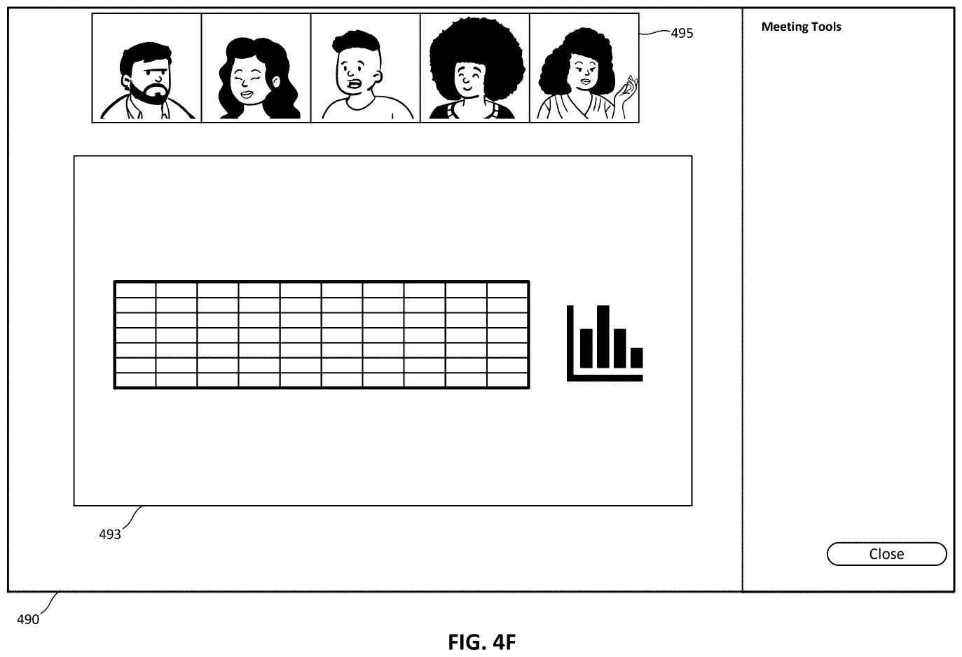

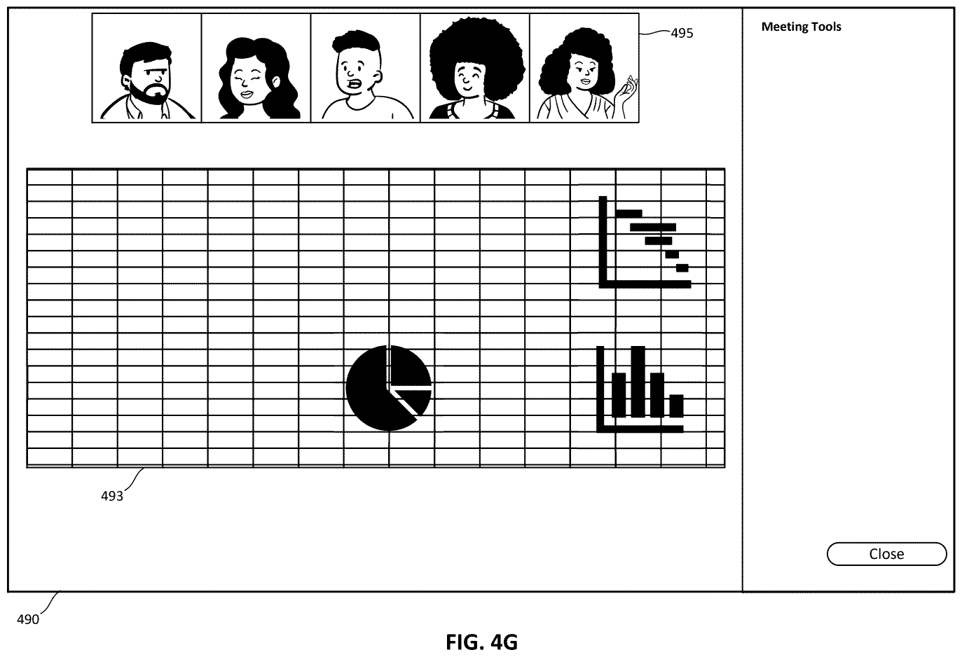

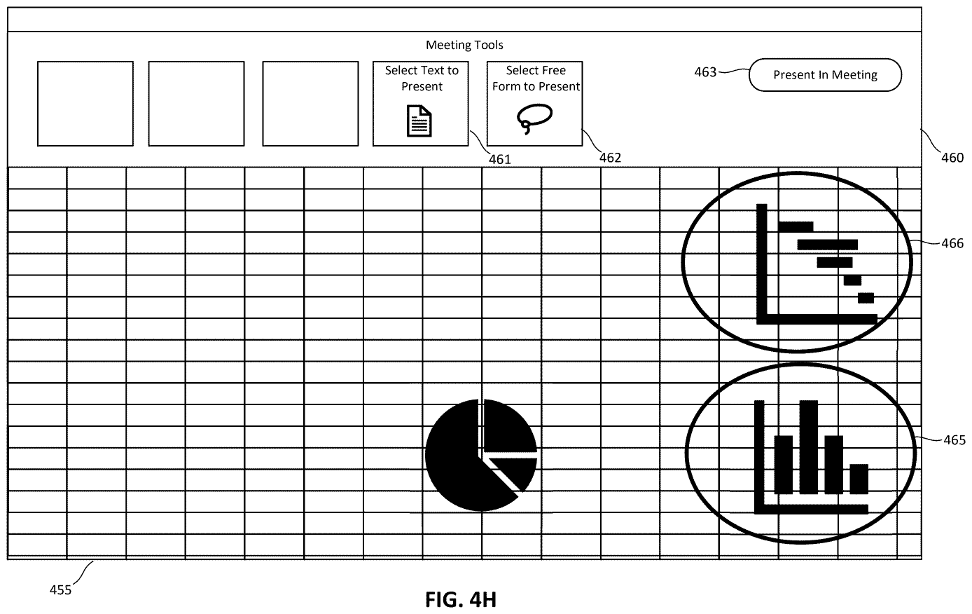

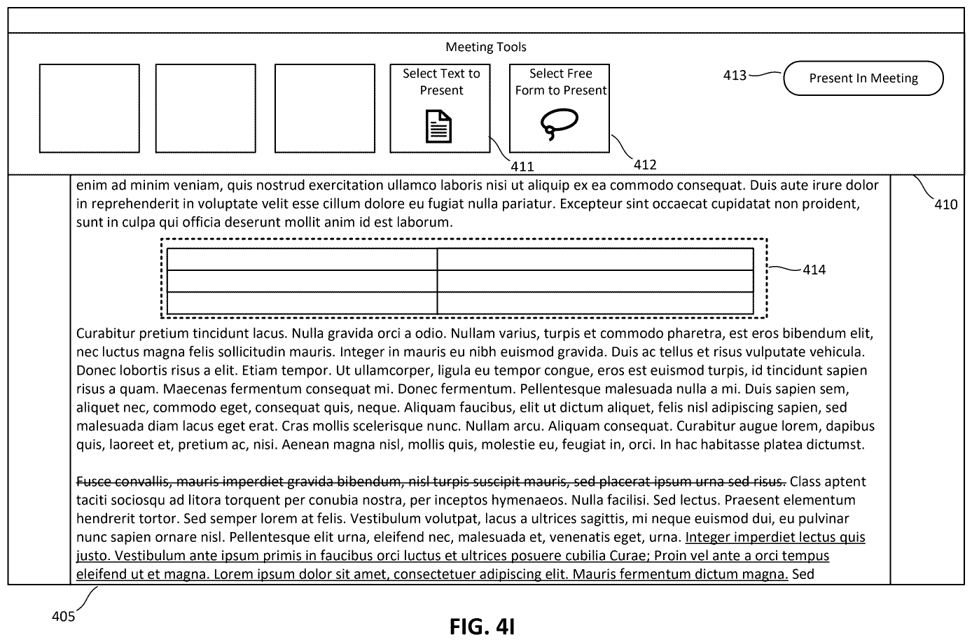

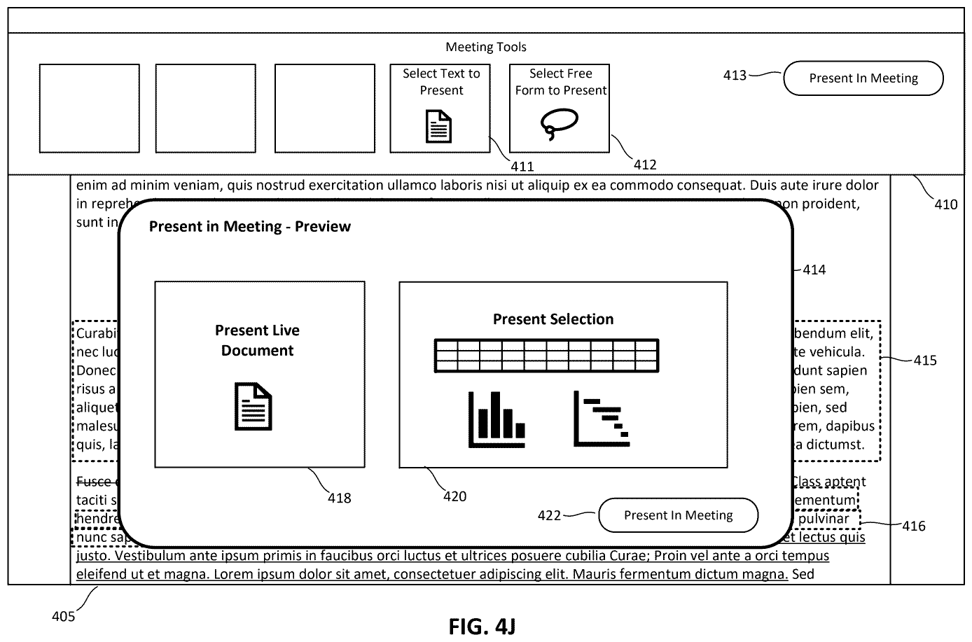

FIG. 4A-4F are diagrams showing example user interfaces in which the content sharing techniques provided herein are utilized. FIG. 4A is a diagram of an example user interface 405 of a word processing application in which an electronic document is presented. The electronic document includes textual content and a table. Other examples may include other content, such as but not limited to images, embedded video, charts, and/or other such content. The textual content of the application includes markup indicating changes that have been made to the document content. Underlined text indicates text that has been inserted, while text that has been struck through is text that was previously deleted. The document may also include other types of markups, such as but not limited to comments from users who have contributed to and/or reviewed the document. Such markup can be confusing and clutter the screen when a user is sharing the document with others during an online meeting. Therefore, as will be discussed in greater detail in the examples which follow, the content sharing unit 118 of the client device 105 or the content sharing unit 172 of the application services platform 110 can remove such markup when generating the graphical representation of the selected content. A technical benefit of this approach is that this markup can be automatically removed from the version of the user selections that are included in the graphical representation presented during the meeting while preserving this valuable markup information in the original version of the document from which the user selections were made.

The user interface 405 may be implemented by a native application on the client device 105 or by the web application 190 on the application services platform 110. The user interface 405 includes meeting tools 410. The meeting tools 410 include various tools that can be used to perform various actions associated with a meeting. The meeting tools 410 includes a select text to present control 411 and a select free form to present control 412. While the example user interface 405 includes just two types of selection, the user interface 405 can provide controls for various types of user selections, such as but not limited to a free-form selection, a rectangular selection of content, text selection/highlighting, and/or a click indicating the selection of a particular object. The select text to present control 411, when clicked on or otherwise activated, enables the user to highlight a section of text to be shared with participants of an online meeting. The select free form to present control 412 enables the user to draw a free form closed shape around a section content to be shared. The user can select multiple user selections using these tools, and the content sharing unit 118 of the client device 105 or the content sharing unit 172 of the application services platform 110 will generate a graphical representation of the multiple user selections to present to the participants of the online meeting.

FIG. 4B shows an example in which the user has selected three portions of the document: user selection 414, user selection 415, and user selection 416. Once the user has completed the selection process, the user clicks on or otherwise activates the present in meeting control 413. Activating the present in meeting control 413 causes the native application or web application to generate the content sharing command that is provided to the content sharing unit 118 of the client device 105 or the content sharing unit 172 of the application services platform 110. In some implementations, the graphical representation of the user selection 414, user selection 415, and user selection 416 is provided to the client devices of the participants of the online meeting in response to the content sharing command. The content sharing unit 118 of the client device and/or the content sharing unit 172 of the application services platform 110 can generate a preview of the graphical representation and present the preview on the client device 105 of the user that selected the content. An example of such a previous is shown in FIG. 4C in a preview pane. The preview includes a present live document control 418 and a present selection control 420. The user can select one of these controls and activate the present in meeting control 422 to cause the graphical representation to be generated and shared with the client devices of the participants of the online meeting. The present selection control 420 includes a proposed layout of the graphical representation of the user selection. In some implementations, the preview pane can include more than one proposed layouts of the graphical representation of the user selections. In such implementations, the graphical representation unit 206 of the content sharing unit 118 or the graphical representation unit 306 of the content sharing unit 172 instructs the layout generation model 182 to generate multiple candidate layouts and/or utilizes templates having different layouts to generate the multiple proposed layouts of the graphical representation.

FIG. 4D is an example user interface 455 of a spreadsheet application. The user interface 455 includes meeting tools 460, which are similar to the meeting tools 410 shown in FIGS. 4A-4C. The meeting tools 460 includes a select text to present control 461 which operates similarly to the select text to present control 411. The meeting tools 460 includes a select free form to present control 462 which operates similarly to the select free form to present control 412. The meeting tools 460 also include a present in meeting control 463 that operates similarly to the present in meeting control 413. In the example shown in FIG. 4D, the user has selected a set of cells of the spreadsheet in user selection 464 and a free-form selection of a chart in user selection 465. FIG. 4E shows the preview pane with the present live document control 467 and present selection control 468. The present selection control 468 includes a preview of the graphical representation of the user selection.

FIG. 4F is an example user interface 490 of an online meeting application associated with the online meeting platform 170. The online meeting application can be implemented as a native application on the client device 105, such as the native application 114, or via a web application on the application services platform, such as the web application 190. The user interface 490 includes a representation of the meeting participants 495 and a graphical representation of the shared content 493. The graphical representation of the shared content in this example is generated from the multiple user selections shown in FIG. 4E.

FIG. 4G is an example user interface 490 of an online meeting application associated with the online meeting platform 170. In this example, the user has selected the option to show the live document rather than the graphical representation. As can be seen from this example, the live document view shows the document content without applying the focus mode. This figure demonstrates how the graphical representation of the user selects shown generated in the focus mode provides a clean and uncluttered view of the selected content for presentation to the participants of the online meeting. Consequently, the meeting efficiency and workflow is improved.

FIGS. 4H, 4I, and 4J provide an example in which multiple user selections are made that include content from different applications. FIG. 4H shows another example of the user interface 455 of the spreadsheet application shown in FIGS. 4D and 4E, in which the user has selected two graphs as user selection 465 and user selection 466. In this example, rather than clicking on or otherwise activating the present in meeting control 463 to cause the content sharing command to cause the content sharing unit 118 of the client device 105 or the content sharing unit 172 of the application services platform 110 to generate the graphical representation of the user selections. Instead, as shown in FIG. 4H, the user accesses the user interface 405 of the word processing application and selects a table from the document as user selection 414. The user then clicks on or otherwise activates the present in meeting control 413 to cause the content sharing unit 118 of the client device 105 or the content sharing unit 172 of the application services platform 110 to generate the graphical representation of the user selections. FIG. 4I shows a preview of the multiple user selections. The user can opt to select the present live document control 418 or the present selection control 420 as discussed in the preceding examples and activate the present in meeting control 422 to cause the graphical representation to be generated and shared with the client devices of the participants of the online meeting.

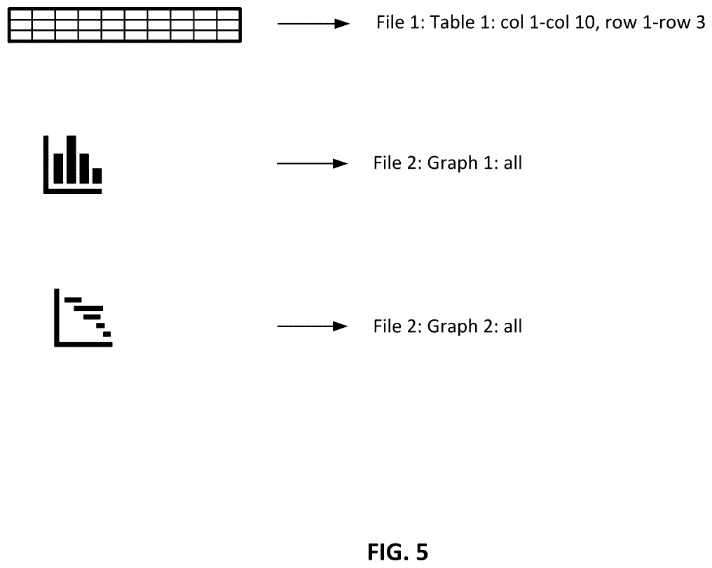

FIG. 5 is a diagram showing an example of the data structures that can be generated by the data extraction unit 202 of the content sharing unit 118 and/or the data extraction unit 302 of the content sharing unit 172. The example shown in FIG. 5 is an example of the user selections used to generate the graphical representation from FIG. 4J. The data extraction unit 202 of the content sharing unit 118 or the data extraction unit 302 of the content sharing unit 172 extract information about each of the user selections. The data extraction unit 202 or data extraction unit 302 then formats the user selection information as a JSON, a database entry, and/or other data structures that can be used to store the user selection information in the local content storage 116 or the cloud-based content storage 174.

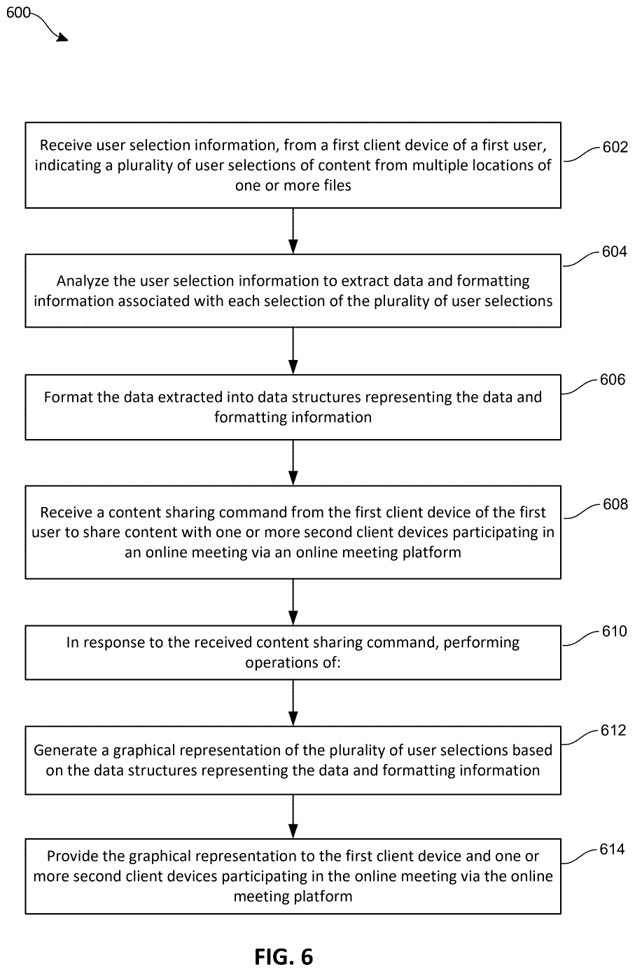

FIG. 6 is a flow chart of an example process 600 for sharing content in an online meeting according to the techniques disclosed herein. The process 600 can be implemented by the content sharing unit 172 of the application services platform 110 shown in FIG. 1 or by the content sharing unit 118 of the client device 105.

The process 600 includes an operation 602 of receiving user selection information, from a first client device of a first user, indicating a plurality of user selections of content from multiple locations of one or more files. As discussed in the preceding examples, one or more native applications, such as the native application 114, and/or the browser application 112 of the client device can provide the user selection information to the content sharing unit 118. In other implementations, web applications, such as the web application 190, on the application services platform 110 can provide the user selection information to the content sharing unit 172 of the application services platform 110.

The process 600 includes an operation 604 of analyzing the user selection information to extract data and formatting information associated with each selection of the plurality of user selections and an operation 606 of formatting the data extracted into data structures representing the data and formatting information. As discussed in the preceding examples, the data extraction unit 202 of the content sharing unit 118 or the data extraction unit 302 of the content sharing unit 172 analyze the user selection information and format the extracted data. The content sharing unit 118 stores the extracted and formatted data in the local content storage 116, and the content sharing unit 172 stores the extracted and formatted data in the cloud-based content storage 174.

The process 600 includes an operation 608 of receiving a content sharing command from the first client device of the first user to share content with one or more second client devices participating in an online meeting via an online meeting platform 170. The content sharing unit 118 of the client device 105 receives the content sharing command, or the content sharing unit 172 of the application services platform 110 receives the content sharing command. As discussed in the preceding examples, the content sharing command can be generated by the native application 114, the browser application 112, or the web application 190.

The process 600 includes an operation 610 of in response to receiving the content sharing command, performing operation an operation 612 of generating a graphical representation of the plurality of user selections based on the data structures representing the data and formatting information and an operation 614 of providing the graphical representation to the first client device and one or more second client devices participating in the online meeting via the online meeting platform. The graphical representation unit 206 of the content sharing unit 118 generates the graphical representation, and the content delivery unit 208 of the content sharing unit 118 provides the graphical representation to the client devices of the participants of the online meeting. Alternatively, the graphical representation unit 306 of the content sharing unit 172 generates the graphical representation, and the content delivery unit 308 of the content sharing unit 172 provides the graphical representation to the client devices of the participants of the online meeting.

A technical benefit of the approach shown in FIG. 6 is that the user can select content from one or more locations in a file and/or from one or more files and the system automatically generates a single graphical representation that includes the shared content in a coherent in streamlined layout that is conducive to sharing in an online meeting. This approach can significantly improve the workflow of online meetings by enabling users to focus on important details of the shared content without being distracted by comments, markups, and portions of the content that are irrelevant to the online meeting. Consequently, this approach can reduce the computing resources utilized by the online meeting platform by making online meetings more efficient and eliminating meeting time that would otherwise be expended on explaining more complicated and unfocused shared content.

The detailed examples of systems, devices, and techniques described in connection with FIGS. 1-6 are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1-6 are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

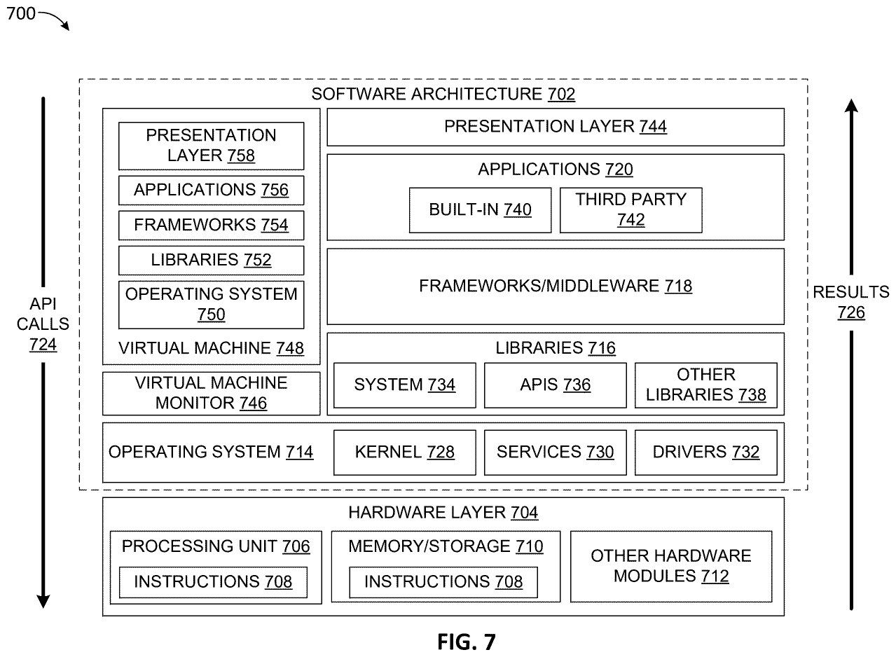

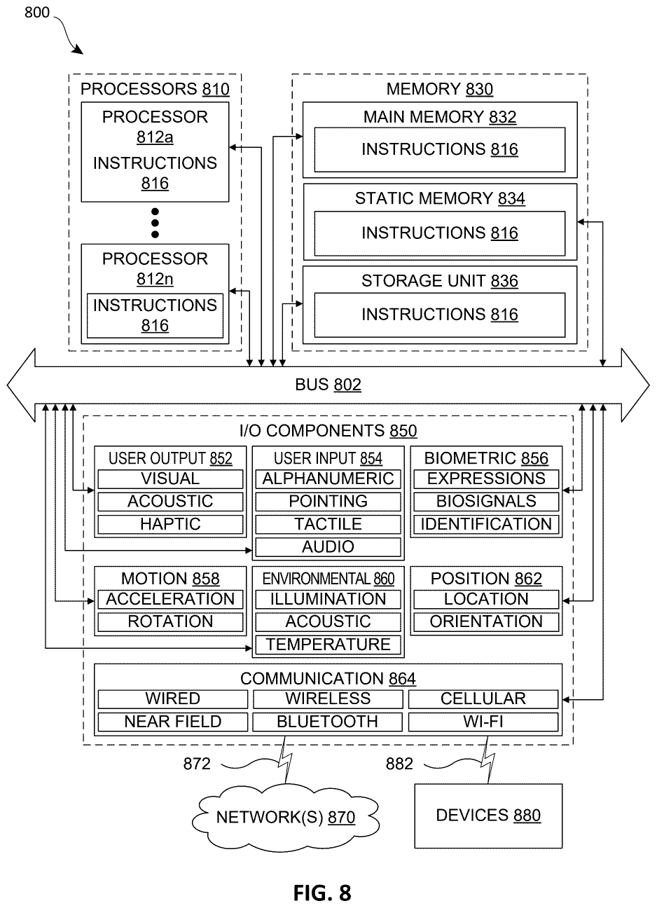

FIG. 7 is a block diagram 700 illustrating an example software architecture 702, various portions of which may be used in conjunction with various hardware architectures herein described, which may implement any of the above-described features. FIG. 7 is a non-limiting example of a software architecture, and it will be appreciated that many other architectures may be implemented to facilitate the functionality described herein. The software architecture 702 may execute on hardware such as a machine 800 of FIG. 8 that includes, among other things, processors 810, memory/storage, and input/output (I/O) components 850. A representative hardware layer 704 is illustrated and can represent, for example, the machine 800 of FIG. 8. The representative hardware layer 704 includes a processing unit 706 and associated executable instructions 708. The executable instructions 708 represent executable instructions of the software architecture 702, including implementation of the methods, modules and so forth described herein. The hardware layer 704 also includes a memory/storage 710, which also includes the executable instructions 708 and accompanying data. The hardware layer 704 may also include other hardware modules 712. Instructions 708 held by processing unit 706 may be portions of instructions 708 held by the memory/storage 710.

The example software architecture 702 may be conceptualized as layers, each providing various functionality. For example, the software architecture 702 may include layers and components such as an operating system (OS) 714, libraries 716, frameworks/middleware 718, applications 720, and a presentation layer 744. Operationally, the applications 720 and/or other components within the layers may invoke API calls 724 to other layers and receive corresponding results 726. The layers illustrated are representative in nature and other software architectures may include additional or different layers. For example, some mobile or special purpose operating systems may not provide the frameworks/middleware 718.

The OS 714 may manage hardware resources and provide common services. The OS 714 may include, for example, a kernel 728, services 730, and drivers 732. The kernel 728 may act as an abstraction layer between the hardware layer 704 and other software layers. For example, the kernel 728 may be responsible for memory management, processor management (for example, scheduling), component management, networking, security settings, and so on. The services 730 may provide other common services for the other software layers. The drivers 732 may be responsible for controlling or interfacing with the underlying hardware layer 704. For instance, the drivers 732 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 716 may provide a common infrastructure that may be used by the applications 720 and/or other components and/or layers. The libraries 716 typically provide functionality for use by other software modules to perform tasks, rather than interacting directly with the OS 714. The libraries 716 may include system libraries 734 (for example, C standard library) that may provide functions such as memory allocation, string manipulation, file operations. In addition, the libraries 716 may include API libraries 736 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 716 may also include a wide variety of other libraries 738 to provide many functions for applications 720 and other software modules.

The frameworks/middleware 718 provide a higher-level common infrastructure that may be used by the applications 720 and/or other software modules. For example, the frameworks/middleware 718 may provide various graphic user interface (GUI) functions, high-level resource management, or high-level location services. The frameworks/middleware 718 may provide a broad spectrum of other APIs for applications 720 and/or other software modules.

The applications 720 include built-in applications 740 and/or third-party applications 742. Examples of built-in applications 740 may include, but are not limited to, a contacts application, a browser application, a location application, a media application, a messaging application, and/or a game application. Third-party applications 742 may include any applications developed by an entity other than the vendor of the particular platform. The applications 720 may use functions available via OS 714, libraries 716, frameworks/middleware 718, and presentation layer 744 to create user interfaces to interact with users.

Some software architectures use virtual machines, as illustrated by a virtual machine 748. The virtual machine 748 provides an execution environment where applications/modules can execute as if they were executing on a hardware machine (such as the machine 800 of FIG. 8, for example). The virtual machine 748 may be hosted by a host OS (for example, OS 714) or hypervisor, and may have a virtual machine monitor 746 which manages operation of the virtual machine 748 and interoperation with the host operating system. A software architecture, which may be different from software architecture 702 outside of the virtual machine, executes within the virtual machine 748 such as an OS 750, libraries 752, frameworks 754, applications 756, and/or a presentation layer 758.

FIG. 8 is a block diagram illustrating components of an example machine 800 configured to read instructions from a machine-readable medium (for example, a machine-readable storage medium) and perform any of the features described herein. The example machine 800 is in a form of a computer system, within which instructions 816 (for example, in the form of software components) for causing the machine 800 to perform any of the features described herein may be executed. As such, the instructions 816 may be used to implement modules or components described herein. The instructions 816 cause unprogrammed and/or unconfigured machine 800 to operate as a particular machine configured to carry out the described features. The machine 800 may be configured to operate as a standalone device or may be coupled (for example, networked) to other machines. In a networked deployment, the machine 800 may operate in the capacity of a server machine or a client machine in a server-client network environment, or as a node in a peer-to-peer or distributed network environment. Machine 800 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 800 is illustrated, the term “machine” includes a collection of machines that individually or jointly execute the instructions 816.

The machine 800 may include processors 810, memory/storage 830, and I/O components 850, which may be communicatively coupled via, for example, a bus 802. The bus 802 may include multiple buses coupling various elements of machine 800 via various bus technologies and protocols. In an example, the processors 810 (including, for example, a central processing unit (CPU), a graphics processing unit (GPU), a digital signal processor (DSP), an ASIC, or a suitable combination thereof) may include one or more processors 812a to 812n that may execute the instructions 816 and process data. In some examples, one or more processors 810 may execute instructions provided or identified by one or more other processors 810. The term “processor” includes a multicore processor including cores that may execute instructions contemporaneously. Although FIG. 8 shows multiple processors, the machine 800 may include a single processor with a single core, a single processor with multiple cores (for example, a multicore processor), multiple processors each with a single core, multiple processors each with multiple cores, or any combination thereof. In some examples, the machine 800 may include multiple processors distributed among multiple machines.

The memory/storage 830 may include a main memory 832, a static memory 834, or other memory, and a storage unit 836, both accessible to the processors 810 such as via the bus 802. The storage unit 836 and memory 832, 834 store instructions 816 embodying any one or more of the functions described herein. The memory/storage 830 may also store temporary, intermediate, and/or long-term data for processors 810. The instructions 816 may also reside, completely or partially, within the memory 832, 834, within the storage unit 836, within at least one of the processors 810 (for example, within a command buffer or cache memory), within memory at least one of I/O components 850, or any suitable combination thereof, during execution thereof. Accordingly, the memory 832, 834, the storage unit 836, memory in processors 810, and memory in I/O components 850 are examples of machine-readable media.

As used herein, “machine-readable medium” refers to a device able to temporarily or permanently store instructions and data that cause machine 800 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 816) for execution by a machine 800 such that the instructions, when executed by one or more processors 810 of the machine 800, cause the machine 800 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 850 may include a wide variety of hardware components adapted to receive input, provide output, produce output, transmit information, exchange information, capture measurements, and so on. The specific I/O components 850 included in a particular machine will depend on the type and/or function of the machine. For example, mobile devices such as mobile phones may include a touch input device, whereas a headless server or IoT device may not include such a touch input device. The particular examples of I/O components illustrated in FIG. 8 are in no way limiting, and other types of components may be included in machine 800. The grouping of I/O components 850 are merely for simplifying this discussion, and the grouping is in no way limiting. In various examples, the I/O components 850 may include user output components 852 and user input components 854. User output components 852 may include, for example, display components for displaying information (for example, a liquid crystal display (LCD) or a projector), acoustic components (for example, speakers), haptic components (for example, a vibratory motor or force-feedback device), and/or other signal generators. User input components 854 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 850 may include biometric components 856, motion components 858, environmental components 860, and/or position components 862, among a wide array of other physical sensor components. The biometric components 856 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 858 may include, for example, acceleration sensors (for example, an accelerometer) and rotation sensors (for example, a gyroscope). The environmental components 860 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 862 may include, for example, location sensors (for example, a Global Position System (GPS) receiver), altitude sensors (for example, an air pressure sensor from which altitude may be derived), and/or orientation sensors (for example, magnetometers).

The I/O components 850 may include communication components 864, implementing a wide variety of technologies operable to couple the machine 800 to network(s) 870 and/or device(s) 880 via respective communicative couplings 872 and 882. The communication components 864 may include one or more network interface components or other suitable devices to interface with the network(s) 870. The communication components 864 may include, for example, components adapted to provide wired communication, wireless communication, cellular communication, Near Field Communication (NFC), Bluetooth communication, Wi-Fi, and/or communication via other modalities. The device(s) 880 may include other machines or various peripheral devices (for example, coupled via USB).

In some examples, the communication components 864 may detect identifiers or include components adapted to detect identifiers. For example, the communication components 864 may include Radio Frequency Identification (RFID) tag readers, NFC detectors, optical sensors (for example, one-or multi-dimensional bar codes, or other optical codes), and/or acoustic detectors (for example, microphones to identify tagged audio signals). In some examples, location information may be determined based on information from the communication components 864, such as, but not limited to, geo-location via Internet Protocol (IP) address, location via Wi-Fi, cellular, NFC, Bluetooth, or other wireless station identification and/or signal triangulation.

In the preceding detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high level, without detail, in order to avoid unnecessarily obscuring aspects of the present teachings.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article, or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor; and
a memory storing executable instructions that, when executed, cause the processor alone or in combination with other processors to perform operations of:
receiving user selection information, from a first client device of a first user, indicating a plurality of user selections of content from multiple locations of one or more files;
analyzing the user selection information to extract data and formatting information associated with each selection of the plurality of user selections;
formatting the data extracted into data structures representing the data and formatting information;
receiving a content sharing command from the first client device of the first user to share content with one or more second client devices participating in an online meeting via an online meeting platform; and
in response to receiving the content sharing command:
generating a graphical representation of the plurality of user selections based on the data structures representing the data and formatting information; and
providing the graphical representation to the first client device and one or more second client devices participating in the online meeting via the online meeting platform.

2. The data processing system of claim 1, wherein to receive the user selection information the memory further includes instructions configured to cause the processor alone or in combination with other processors to perform operations of:
receiving an indication from the first client device to share the graphical representation with the one or more second client devices associated with one or more second users participating in an online meeting with the first user;
providing the graphical representation to an online meeting platform that is coordinating the online meeting; and
instructing the online meeting platform to present the graphical representation in a video stream being sent to the one or more second client devices.

3. The data processing system of claim 1, wherein to receive the user selection information the memory further includes instructions configured to cause the processor alone or in combination with other processors to perform operations of:
receiving the user selection information as a series of user selection information as each user selection of the plurality of user selections is completed;
receiving an indication from the first client device that the first user has completed selection of the plurality of user selections; and
responsive to receiving the indication, analyzing the user selection information to extract the data and formatting information.

4. The data processing system of claim 1, wherein to generate the graphical representation of the plurality of user selections, the memory further includes instructions configured to cause the processor alone or in combination with other processors to perform operations of:
automatically generating one or more proposed layouts of a representation of user selections as a single electronic document based on the data structures representing the data and formatting information;
providing the one or more proposed layouts of the representation of the user selections to the first client device;
receiving an indication from the first client device selecting a respective proposed layout from among the one or more proposed layouts; and
generating the representation of the plurality of user selections based on the respective proposed layout.

5. The data processing system of claim 1, wherein the plurality of user selections are from different types of content.

6. The data processing system of claim 1, wherein the memory further includes instructions configured to cause the processor alone or in combination with other processors to perform operations of:
receiving the user selection information as a series of user selection information as each user selection of the plurality of user selections is completed;
creating a user session in a memory of the data processing system, the user session including a timer that counts from a time that a most recent user selection information is received from the first client device;
determining that the timer has elapsed; and
responsive to determining that the timer has elapsed, analyzing the user selection information to extract the data and formatting information.

7. The data processing system of claim 1, wherein to analyze the user selection information to extract data and formatting information associated with each selection of the plurality of user selections the memory further includes instructions configured to cause the processor alone or in combination with other processors to perform operations of:
constructing a prompt to a language model instructing the language model to analyze the user selection information and to output the data and formatting information associated with each selection of the plurality of user selections; and
providing the prompt as an input to the language model to cause the language model to output the data and formatting information associated with each selection of the plurality of user selections.

8. The data processing system of claim 1, wherein the user selection information includes one or more of a free-form selection of content, a rectangular selection of content, or a click indicating a selection of a particular object.

9. The data processing system of claim 1, wherein to generate one or more proposed layouts of a representation of user selections as a single electronic document, the memory further includes instructions configured to cause the processor alone or in combination with other processors to perform operations of:
constructing a prompt to a layout generation model to cause the layout generation model to generate the one or more proposed layouts of the representation of the user selections; and
providing the prompt as an input to the layout generation model to cause the layout generation model to output the one or more proposed layouts of a representation of user selections.

10. The data processing system of claim 1, wherein to format the data extracted into data structures representing the data and formatting information, the memory further includes instructions configured to cause the processor alone or in combination with other processors to perform operations of:
generating a JavaScript Object Notation representation of the data and formatting information.

11. The data processing system of claim 1, wherein to format the data extracted into data structures representing the data and formatting information, the memory further includes instructions configured to cause the processor alone or in combination with other processors to perform operations of:
generating a lightweight database representation of the data and formatting information.

12. A method implemented in a data processing system for sharing content in an online meeting, the method comprising:
receiving user selection information, from a first client device of a first user, indicating a plurality of user selections of content from multiple locations of one or more files;
analyzing the user selection information to extract data and formatting information associated with each selection of the plurality of user selections;
formatting the data extracted into data structures representing the data and formatting information;
receiving a content sharing command from the first client device of the first user to share content with one or more second client devices participating in an online meeting via an online meeting platform; and
in response to receiving the content sharing command:
generating a graphical representation of the plurality of user selections based on the data structures representing the data and formatting information; and
providing the graphical representation to the first client device and one or more second client devices participating in the online meeting via the online meeting platform.

13. The method of claim 12, wherein receiving the user selection information further comprises:
receiving an indication from the first client device to share the graphical representation with the one or more second client devices associated with one or more second users participating in an online meeting with the first user;
providing the graphical representation to an online meeting platform that is coordinating the online meeting; and
instructing the online meeting platform to present the graphical representation in a video stream being sent to the one or more second client devices.

14. The method of claim 12, wherein receiving the user selection information further comprises:
receiving the user selection information as a series of user selection information as each user selection of the plurality of user selections is completed;
receiving an indication from the first client device that the first user has completed selection of the plurality of user selections; and
responsive to receiving the indication, analyzing the user selection information to extract the data and formatting information.

15. The method of claim 12, wherein generating the graphical representation of the plurality of user selections further comprises:
automatically generating one or more proposed layouts of a representation of user selections as a single electronic document based on the data structures representing the data and formatting information;
providing the one or more proposed layouts of the representation of the user selections to the first client device;
receiving an indication from the first client device selecting a respective proposed layout from among the one or more proposed layouts; and
generating the representation of the plurality of user selections based on the respective proposed layout.

16. The method of claim 12, wherein the plurality of user selections are from different types of content.

17. The method of claim 12, further comprising:
receiving the user selection information as a series of user selection information as each user selection of the plurality of user selections is completed;
creating a user session in a memory of the data processing system, the user session including a timer that counts from a time that a most recent user selection information is received from the first client device;
determining that the timer has elapsed; and
responsive to determining that the timer has elapsed, analyzing the user selection information to extract the data and formatting information.

18. The method of claim 12, wherein analyzing the user selection information to extract data and formatting information associated with each selection of the plurality of user selections further comprises:
constructing a prompt to a language model instructing the language model to analyze the user selection information and to output the data and formatting information associated with each selection of the plurality of user selections; and
providing the prompt as an input to the language model to cause the language model to output the data and formatting information associated with each selection of the plurality of user selections.

19. The method of claim 12, wherein the user selection information includes one or more of a free-form selection of content, a rectangular selection of content, or a click indicating a selection of a particular object.

20. A machine-readable medium on which are stored instructions that, when executed, cause a processor of alone or in combination with other processors to perform operations of:
receiving user selection information, from a first client device of a first user, indicating a plurality of user selections of content from multiple locations of one or more files;
analyzing the user selection information to extract data and formatting information associated with each selection of the plurality of user selections;
formatting the data extracted into data structures representing the data and formatting information;
receiving a content sharing command from the first client device of the first user to share content with one or more second client devices participating in an online meeting via an online meeting platform; and
in response to receiving the content sharing command:
generating a graphical representation of the plurality of user selections based on the data structures representing the data and formatting information; and
providing the graphical representation to the first client device and one or more second client devices participating in the online meeting via the online meeting platform.
